(19) United States
(12) Patent Application Publication
(10) Pub. No.: US 2010/0066039 A1
(43) Pub. Date: Mar. 18, 2010

(54) ADJUSTMENT DRIVE FOR THE LOCAL ADJUSTMENT OF A CHASSIS COMPONENT

(75) Inventors: Christoph Koch, Ostercappeln (DE); Andreas Gartner, Bremen (DE); Marc Wiesenthal, Osnabruck (DE); Dylan Robinson, Haltern am See (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/513,233

(22) PCT Filed: Oct. 31, 2007
(86) PCT No.: PCT/DE07/01960

§ 371 Date: May 1, 2009

(30) Foreign Application Priority Data
Nov. 3, 2006 (DE) 10 2006 052 253.2

(51) Int. Cl. F16H 19/02; B60G 7/00; B62D 17/00

(52) U.S. Cl. 280/5.52; 475/162; 74/89.16

(57) ABSTRACT

An adjustment drive for local adjustment of a chassis component. The drive including a mounting (8), a first wheel (1) having a common first center line (9) and rotational axis, a second wheel (2), which is eccentric to the first wheel (1), has a second center line (13) that is parallel to the first center line (9), a third wheel (3) having a common third center line (10) and rotational axis. The third center line is either parallel to or coincident with the first center line (9). A drive system (16) is coupled to the mounting (8) and rotates at least the first and third wheels (1, 3). The second wheel (2) is eccentric to the third wheel (3) and is supported thereon so as to rotate about the second center line (13), and the first wheel (1) is coupled to the second wheel (2) for transmitting rotational motion.

This application is a National Stage completion of PCT/DE2007/001960 filed Oct. 31, 2007, which claims priority from German patent application serial no. 10 2006 052 253.2 filed Nov. 3, 2006.

### FIELD OF THE INVENTION

The invention relates to an adjustment drive for the local adjustment of a chassis component with a mounting, a first wheel having a first center line and rotatable around it, a second wheel that is disposed eccentrically to the first wheel and has a second center line which is oriented parallel to the first center line, a third wheel having a third center line and rotatable around it which is aligned parallel to the first center line or coincides with it, and a drive system that is coupled to the mounting from which at least the first and third wheels and can rotate. The invention further relates to the use of such an adjustment drive and to a vehicle with such an adjustment drive.

### BACKGROUND OF THE INVENTION

Such adjustment drives are known from the state of the art. WO 2005/080826 A1, for example, discloses an actuator for adjusting the steering rod of a vehicle steering system, wherein a motor is fastened to a mounting having a recess with inwardly pointing teeth, meshing with outwardly pointing teeth of a gear wheel which is coupled to a motor shaft of the motor and to an actuator rod that carries out a linear movement when the motor shaft rotates, and which is coupled to the steering rod. Furthermore, a second gear wheel may be provided which is coupled to the actuator rod whose outwardly pointing teeth mesh with the inwardly pointed teeth.

DE 25 11 660 B1 describes a mechanical reducing gear for converting rotary movement into reciprocating movement, comprising a planetary gearbox, the planet gears of which have half the diameter of the sun gear with internal teeth. In order to drive the planet gears, a face plate is provided which has a plurality of openings on the front to selectively receive the planet gears during the interposition of driving pins. The reducing gear is used to precisely adjust the controlled variable of the actuator intervening in the controlled system, particularly a control valve or control flap.

US 2004/0194986 A1 discloses an electrical tool, wherein rotary motion of a motor is converted into reciprocating motion of a hammer. The conversion is achieved by way of a gear wheel driven by a motor shaft of a motor on which is eccentrically fastened a first pin on which a planet gear is supported. The outer teeth of the planet gear engages with in the inner teeth of a sun gear which can rotate during a change of load but otherwise is disposed in a rotationally fixed manner in a housing. On the planet gear a second pin is eccentrically disposed on which a crank arm is rotatably supported that carries out a reciprocating motion for driving the hammer. According to one variant, the planet gear is connected to the first pin during the interposition of a crank, wherein a balancing weight is supported on the second pin and is moved back and forth by the second pin. In this case, the hammer is supported on the first pin, in order to carry out the reciprocating motion during the interposition of the crank arm.

From JP 2000-346161, a planetary gear set is known, wherein the conversion between linear and rotary motion is performed between a crankshaft and a connecting bar. A crank mechanism features a rotor which can be rotated about an axis concentric to the crankshaft and a crank which is rotatably supported on the rotor and connected to the connecting bar.

The disadvantage with these known solutions is that the transmission gears or gear wheels also must be configured comparatively small to achieve a relatively small linear overall stroke which generally can only be realized with higher production effort and/or material costs to simultaneously ensure high load-bearing capacity of these wheels. In the chassis of a vehicle, however, relatively small overall strokes, for example when changing the effective length of a control arm, are desirable.

### SUMMARY OF THE INVENTION

Based on this state of the art, the underlying object of the invention is to refine the adjustment drive of the kind mentioned above, such that a relatively small overall stroke can be implemented with transmission gears having a comparatively large diameter.

The adjustment drive, according to the invention, for the local adjustment of a chassis component comprises a mounting, a first wheel having a first center line and rotatable about the same, a second wheel that is disposed eccentrically to the first wheel and has a second center line, which is oriented parallel to the first center line, a third wheel having a third center line and rotatable about the same, which is oriented parallel to the first center line or coincides with it, and a drive system that is coupled to the mounting and can rotate at least the first and third wheels. The second wheel is disposed eccentrically to the third wheel and is rotatably supported thereon about the second center line, and the first wheel is coupled, particularly in a positive manner, to the second wheel for transmitting rotary motion. The second wheel preferably can additionally be rotated about the third center line, in particular together with the third wheel. Furthermore, the wheels can each be rotated about their center lines, particularly relative to the mounting.

In the adjustment drive according to the invention, a first cam is formed by the first wheel and the second wheel, and a second cam is formed by the second wheel and the third wheel. This dual cam makes it possible to implement a relatively small overall stroke with a comparatively large diameter of the wheels. In principle, the adjustment drive, however, must be adapted to the respective application, therefore the invention is not limited to a small overall stroke and/or to wheels having large diameters.

The drive system may be fastened to, or supported on, the mounting and is preferably configured as a motor, particularly as an electric motor. Alternatively, however, the drive system can also be operated hydraulically or pneumatically. The first wheel and the third wheel can be rotated by the drive system directly or indirectly. Furthermore, the second wheel can be rotated at least indirectly by the drive system.

Adjustment movement of the adjustment drive is carried out relative to the mounting and is picked up at a coupling point or pick-up location which in particular is provided on the second wheel. The adjustment movement is preferably carried out in a linear or substantially linear fashion. The first wheel can furthermore be rotated in particular in the opposite direction of the third wheel. In this way, rotation brought about by the first cam can be entirely or partially compensated for by rotation in the opposite direction caused by the second cam, such that the pick-up location carries out linear or substantially linear motion relative to the mounting.

The second wheel can rotate about the second center line in the same direction as the first wheel. Furthermore, the second wheel can rotate about the third center line in the same direction as the third wheel. The third wheel can rotate in particular in the opposite direction from the first wheel. As a result, the second wheel can rotate simultaneously about the third center line, particularly in the opposite direction from the first wheel, and about the second center line, particularly in the opposite direction from the third wheel. Furthermore, the second wheel can rotate simultaneously about the second center line, particularly in the same direction as the first wheel, and about the third center line, particularly in the same direction as the third wheel.

The first wheel and the second wheel can be coupled by means of at least one positive transmission element, such as a toothed belt. The first wheel, however, preferably has an initial gearing on the circumference and the second wheel has a second gearing on the circumference engaging in the first teeth, such that the first wheel is configured as a first gear wheel and the second wheel as a second gear wheel which meshes with the first gear wheel. In particular, one set of teeth is configured as inner teeth and the other set of teeth as outer teeth, such that the first wheel and the second wheel form a so-called internal gear pair. A wheel having internal teeth can also be referred to as a ring gear.

The first wheel can be supported on the mounting so as to rotate about the first center line, the first center line being in particular stationary relative to the mounting. Furthermore, the third wheel can be supported on the mounting so as to rotate about the third center line, the third center line being in particular stationary relative to the mounting.

The first wheel can be coupled to the third wheel, particularly in a positive manner, in order to transmit rotary motion, for which purpose one or more wheels can be interposed. The first wheel can be coupled to a fourth wheel having a fourth center line and being able to rotate about the same, particularly in a positive manner, for example in order to transmit rotary motion, the fourth center line being oriented parallel to the first center line, wherein the fourth wheel is additionally coupled to the third wheel, particularly in a positive manner, to transmit rotary motion. Furthermore, the first wheel can be coupled to a fifth wheel in a positive manner, having a fifth center line and being able to rotate about the same, in order to transmit rotary motion, the fifth center line being oriented parallel to the first center line. The fifth wheel is additionally coupled to the fourth wheel in a positive manner, in order to transmit rotary motion. In this case, the first wheel is coupled to the fourth wheel while interposing the fifth wheel. The first wheel can be connected to a sixth wheel in a rotationally fixed manner and disposed concentrically thereto, or it can be configured as one piece therewith, which is coupled to the fifth wheel in a positive manner to transmit rotary motion. In this case, the first wheel is coupled to the fourth wheel while interposing the sixth wheel and the fifth wheel. The first wheel and the sixth wheel are offset from each other in the direction of the rotational axes thereof. In this way, it is possible to couple the first wheel and the third wheel to each other using a suitable gear ratio, wherein the ratios can preferably be determined via the diameters of the wheels.

The fourth wheel can be supported on the mounting so as to rotate about the fourth center line, the fourth center line being stationary relative to the mounting. Furthermore, the fifth wheel can be supported on the mounting so as to rotate about the fifth center line, the fifth center line being stationary relative to the mounting. To this end, the fourth center line and the fifth center line can have a distance from each other or coincide.

The wheels can be coupled to each other by means of at least one positive transmission element, for example a toothed belt. The third wheel, however, preferably has a third gearing on the circumference, and the fourth wheel has a fourth gearing on the circumference which engages in the third teeth. In this way, the third wheel can be configured as the third gear wheel and the fourth wheel as the fourth gear wheel which meshes with the third gear wheel. The fourth gearing can additionally engage the first teeth, such that the fourth gear wheel meshes with the first gear wheel and with the third gear wheel. In this case, the fifth wheel and/or the sixth wheel can be omitted. Furthermore, the fifth wheel can have a fifth gearing on the circumference which engages the first teeth or sixth teeth that may be provided on the circumference of the sixth wheel. In this way, the fifth wheel can be configured as the fifth gear wheel, which meshes with the first gear wheel or the sixth wheel configured as the sixth gear wheel. The fifth wheel can engage with the fifth gearing in the fourth gearing of the fourth wheel such that the fifth gear wheel meshes with the fourth gear wheel. Alternatively, the fifth wheel can be disposed concentrically to the fourth wheel and can be connected thereto so as not to rotate, or it is configured as one piece therewith, wherein the fourth wheel and the fifth wheel are offset from each other in the direction of the rotational axes thereof.

The teeth of the wheels can be configured around the entire or part of the circumference, such that each set of teeth forms a complete or partial toothed ring which is disposed concentrically to the axis of the respective wheel and is preferably fastened thereon so as not to rotate or it is configured as one piece therewith.

The third wheel can be configured, for example, as a disk, and the second wheel can have a protrusion or extension which engages in a recess of the third wheel or the disk and is supported so as to rotate while interposing a rolling or plain bearing. Alternatively, a protrusion or extension can be provided on the third wheel and engage a recess of the second wheel, which is supported so as to rotate on the extension while interposing a rolling or plain bearing.

According to a first variant, the first gearing is configured as the outer gearing and the second gearing as the inner gearing, such that the first gear wheel forms the inner gear wheel of the internal gear pair composed of the first gear wheel and the second gear wheel. In particular, the fourth gearing engages in the fifth gearing. The third gearing, the fourth gearing, the fifth gearing, and the sixth gearing are configured as an outer gearing, such that the third gear wheel and the fourth gear wheel, the fourth gear wheel and the fifth gear wheel, and the fifth gear wheel and the sixth gear wheel each form external gear pairs. Furthermore, the wheels may be disposed, such that the first center line, the fourth center line, and the fifth center line are offset from each other along a straight line. The third center line may intersect this straight line, in particular it can coincide with the first center line.

According to a modification of the first variant, the third gear wheel has an inner gearing in which the outer gearing of the fourth gear wheel engages and which additionally engage in the outer gearing of the first gear wheel, such that the third gear wheel and the fourth gear wheel form an internal gear pair and the fourth gear wheel and the first gear wheel form an external gear pair. The fifth wheel and/or the sixth wheel can be omitted in this modification. Alternatively, the sixth gear wheel can be connected concentrically and non-rotatably to the first gear wheel, such that the outer gearing of the fourth gear wheel engages the inner gearing of the third gear wheel and in the outer gearing of the sixth gear wheel. In this case, the outer gearing of the fourth gear wheel does not engage the outer gearing of the first gear wheel.

According to a second variant, the first gearing is configured as an inner gearing and the second gearing an as outer gearing, such that the second gear wheel forms the inner gear wheel of the internal gear pair composed of the first gear wheel and the second gear wheel. An eccentric shaft can be connected in a non-rotatable manner to the third wheel, or can be configured as one piece therewith, wherein the second wheel is supported eccentrically on the third wheel, particularly while interposing the eccentric shaft. The eccentric shaft is disposed concentrically to the third wheel, wherein the second wheel is preferably disposed eccentrically on the eccentric shaft so as to rotate about the second center line. The eccentric shaft may comprise a first cylindrical body that is disposed eccentrically thereto, the body being connected to the eccentric shaft so as not to rotate or it is configured as one piece therewith. The second wheel being supported so as to rotate about the second center line on the body or the lateral surface thereof, the second center line in particular coinciding with the center line of the cylindrical body. A second cylindrical body or ring can be connected to the second wheel so as not to rotate or it can be configured as one piece therewith, the body or ring being disposed eccentrically to the second wheel. The adjustment movement can be picked up on the second cylindrical body or ring, such that it forms the pick-up location. The second cylindrical body or ring is preferably guided in a linear fashion. The eccentric shaft overall provides the adjustment drive with greater stability and can be regarded, for example, as an extension of the third wheel. The third gearing, the fourth gearing, and the fifth gearing are each preferably configured as an outer gearing, such that the third gear wheel and the fourth gear wheel form an external gear pair and the fifth gear wheel and the first gear wheel form an internal gear pair. The fourth wheel can be disposed concentrically to the fifth wheel and connected thereto so as not to rotate. Furthermore, the second gear wheel, the first gear wheel, and the third gear wheel can be positioned in an offset manner from each other along a straight line. The third center line preferably coincides with the first center line.

The adjustment drive according to the invention is used particularly in the chassis of a vehicle to adjust the effective length of a control arm in a chassis of the vehicle, or to displace a chassis component relative to the automotive body of the vehicle. The mounting may be fastened to the automotive body, a chassis subframe, or an auxiliary frame, while the pick-up location is connected to the chassis component, such as a vehicle wheel, a steering knuckle, a wheel carrier, the control arm, a steering rod or tie bar, a ball joint, an elastomer bearing or the like. Alternatively, the mounting may be fastened to the chassis component, while the pick-up location is connected to the automotive body, the chassis subframe, or the auxiliary frame. The chassis subframe or the auxiliary frame can be connected to the automotive body in a fixed manner and it can be added to it. Furthermore, the chassis subframe can be clamped with respect to the automotive body. The mounting may in particular comprise a hollow-cylindrical rim in which at least the first wheel, the second wheel, and the third wheel are disposed. A joint or elastomer bearing may additionally be fastened to the mounting, wherein the rim and the joint or elastomer bearing can be disposed on, or fastened to, different free ends of the mounting. In particular, it is possible to integrate the adjustment drive according to the invention in a control arm or connect it thereto by means of which a vehicle wheel is linked to an automotive body, an auxiliary frame, or a chassis subframe. In this way, the position of a vehicle wheel relative to the automotive body can be adjusted by means of the adjustment drive. The joint is preferably a ball joint.

Furthermore, a chassis subframe or an auxiliary frame can be moved or adjusted with respect to the automotive body by means of the adjustment drive according to the invention. In this way, it is possible to adjust a vehicle axle disposed on the chassis subframe or auxiliary frame to control it. For this purpose, at least one adjustment drive according to the invention may be disposed between the automotive body and the chassis subframe or auxiliary frame. The mounting is connected to the automotive body and the pick-up location is connected to the chassis subframe or auxiliary frame, or the pick-up location is connected to the automotive body and the mounting is connected to the chassis subframe or auxiliary frame. Preferably, however, a plurality of, which is to say two, three, or four adjustment drives according to the invention are provided to adjust the chassis subframe or auxiliary frame, wherein each of these adjustment drives, as described above, may be disposed between the automotive body and the chassis subframe or auxiliary frame. The chassis subframe or auxiliary frame may be fastened to the automotive body via the chassis subframe bearing or auxiliary frame bearing, thereby allowing one or more of these bearings to be connected to the adjustment drive according to the invention or to be configured in an integrated manner with it.

The invention further relates to the use of an adjustment drive for the local adjustment of a chassis component of a vehicle relative to an automotive body of the vehicle. The adjustment drive in particular can be an adjustment drive according to the invention that is refined according to all the embodiments described. To this end, the position of a vehicle wheel relative to the automotive body is preferably adjusted by means of the adjustment drive.

In addition, the invention relates to a vehicle, particularly a motor vehicle, comprising an automotive body, at least one chassis component, and an adjustment drive according to the invention, which is disposed in particular between the automotive body and the chassis component, such as a vehicle wheel. Since the adjustment drive involves an adjustment drive according to the invention, it can be refined according to all the embodiments described above. The position of a chassis component relative to the automotive body can in particular be adjusted by means of the adjustment drive.

Of use in the invention is the direct conversion of rotational motion into longitudinal motions, wherein the use of common, commercially available electric motors as the drive system is possible. To this end, no linear guides such as sliding gates or the like, are required and which operate with poor efficiencies due to friction effects and generally are subject to wear and are not devoid of play.

With the invention, straight guidance can be implemented. Furthermore, the kinematic conditions can be configured, such that in defined positions translational loads acting in a defined direction do not exert pressure on the rotary input or output (dead-center positions). Adjustment positions of the coupling point requiring no retention can in particular be implemented by way of specific gear wheel combinations, whereby an improved fail-safe system is achieved, self-locking mechanisms of the system can be foregone, and the drive system does not have to generate any holding torque. The coupling point to this end corresponds to the pick-up location at which the adjustment movement is picked up.

### BRIEF DESCRIPTION OF THE DRAWINGS

The invention will be described below based on preferred embodiments with reference to the figures. The figures show:

FIG. 1 a schematic sectional view of an adjustment drive according to a first embodiment of the invention,

FIG. 2 a schematic top view of the adjustment drive according to FIG. 1,

FIG. 3 a schematic sectional view of an adjustment drive according to a second embodiment of the invention,

FIG. 4 a schematic top view of the adjustment drive according to FIG. 3,

FIG. 5 a perspective view of a control arm connected to an adjustment drive according to the invention for connecting a vehicle wheel to an auxiliary frame,

FIG. 6 a perspective view of a control arm comprising an adjustment drive according to the invention for connecting a vehicle wheel to an automotive body,

FIG. 7 a schematic top view of a vehicle wheel comprising at least one adjustment drive according to the invention, and

FIG. 8 a schematic sectional view of an adjustment drive according to a modification of the first embodiment of the invention.

### DETAILED DESCRIPTION OF THE PREFERRED EMBODIMENTS

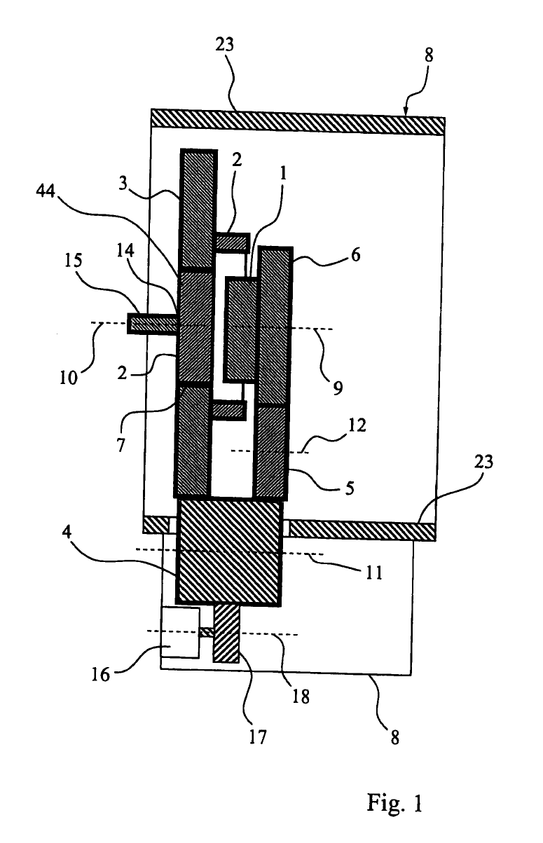

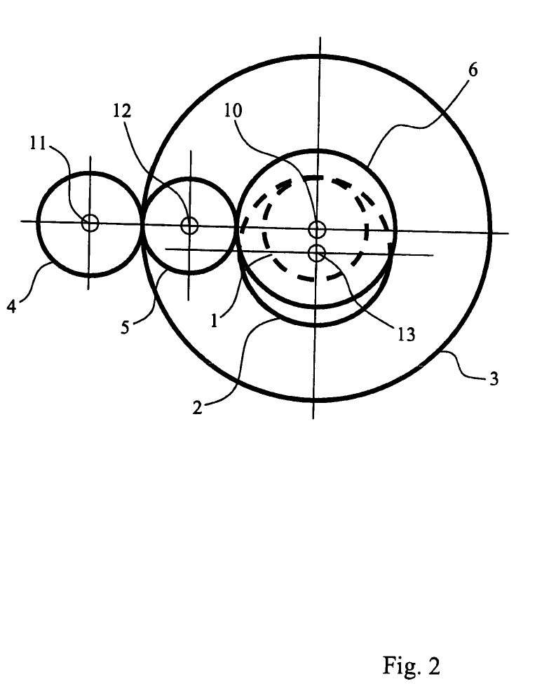

Schematic views of an adjustment drive according to a first embodiment of the invention are seen in FIG. 1 and FIG. 2, wherein a first gear wheel 1 with outer gearing engages in inner gearing of a second gear wheel 2, which is disposed eccentrically to the first gear wheel 1. The second gear wheel 2 is furthermore disposed eccentrically to a third gear wheel 3 and supported so as to rotate therein by means of an extension 44. Outer gearing of the third gear wheel 3 engages with outer gearing of a fourth gear wheel 4, which also engage the outer teeth of a fifth gear wheel 5. A sixth gear wheel 6 is disposed concentrically to the first gear wheel 1 and connected thereto so as not to rotate, or it is configured as one piece therewith, wherein the outer teeth of the sixth gear wheel 6 engage in the outer teeth of the fifth gear wheel 5.

To this end, the rotational axis 9 of the first gear wheel 1 coincides with its center line, the rotational axis 10 of the third gear wheel 3 coincides with its center line, the rotational axis 11 of the fourth gear wheel 4 coincides with its center line, the rotational axis 12 of the fifth gear wheel 5 coincides with its center line, and the rotational axis 13 of the second gear wheel 2 with its center line.

The second gear wheel 2 is rotationally supported in the third gear wheel 3 by way of the extension 44, while interposing a rolling or plain bearing 7. Furthermore, the first gear wheel 1 together with the sixth gear wheel 6, the third gear wheel 3, the fourth gear wheel 4, and the fifth gear wheel 5 are each supported so as to rotate on a schematically illustrated mounting 8. To this end, the rotational axis 9 of the first gear wheel 1 and the sixth gear wheel 6, the rotational axis 10 of the third gear wheel 3, the rotational axis 11 of the fourth gear wheel 4, and the rotational axis 12 of the fifth gear wheel 5 are fixed relative to the mounting 8. The rotational axis 9 of the first gear wheel 1 and the sixth gear wheel 6 is coincident with the rotational axis 10 of the third gear wheel 3.

An adjustment movement can be picked up at a pick-up location 14, which in the present example is provided on the second gear wheel 2 and can exhibit a distance to the rotational axis 13. According to this embodiment, an extension 15 on the pick-up location 14 is fastened to, or supported on, the second gear wheel 2, via which the adjustment movement is picked up. In particular, the extension 15 may engage in a recess which is provided in the second gear wheel 2 at the pick-up location 14. Adjustment movement is carried out relative to the mounting 8 and is linear or substantially linear.

A drive system 16 is fastened to the mounting 8 and rotationally drives a drive gear wheel 17 about a rotational axis 18. The driving gear wheel 17 comprises outer teeth, which engage the outer teeth of gear wheel 4, such that the driving gear wheel 17 meshes with the gear wheel 4 which can be rotationally driven about the rotational axis 11 by means of the drive system 16. By way of the fourth gear wheel 4, the third gear wheel 3 can be rotationally driven about the rotational axis 10 and the fifth gear wheel 5 about the rotational axis 12, by means of which the sixth gear wheel 6 and hence also the first gear wheel 1 can be rotationally driven about the rotational axis 9.

The mounting 8 comprises a hollow-cylindrical rim 23 in which the first gear wheel 1, the second gear wheel 2, the third gear wheel 3, the fifth gear wheel 5, and the sixth gear wheel 6 are disposed. The fourth gear wheel 4 is supported in this example outside the hollow-cylindrical rim 23 and extends through a wall of the hollow-cylindrical rim 23, such that the fourth gear wheel 4 can mesh with the third gear wheel 3 and the fifth gear wheel 5.

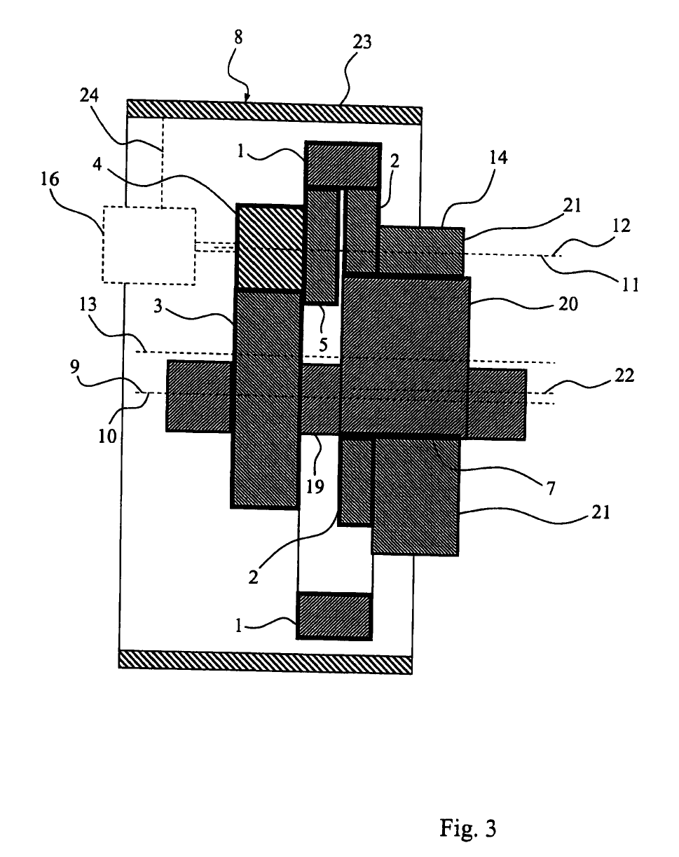

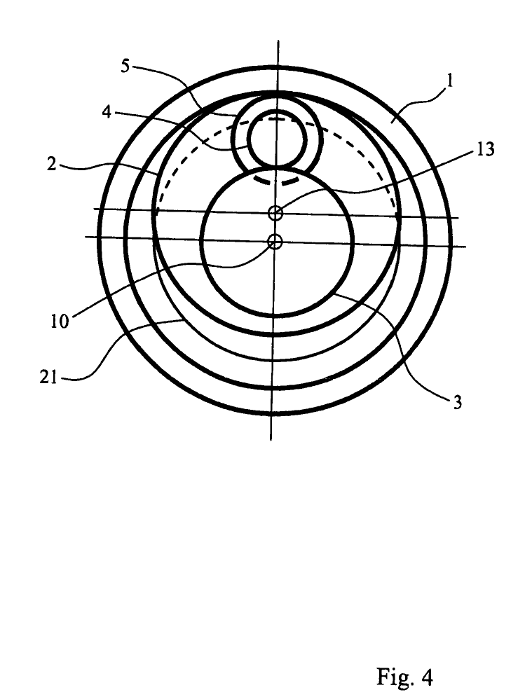

In FIG. 3 and FIG. 4 schematic views of an adjustment device according to a second embodiment of the invention are apparent, wherein characteristics identical or similar to the first embodiment are denoted with the same reference numerals as in the first embodiment.

Inner gearing of a first gear wheel 1 engages with an outer gearing of a second gear wheel 2, which is disposed eccentrically to the first gear wheel 1. The second gear wheel 2 is disposed eccentrically to a third gear wheel 3 and is supported by an interconnecting eccentric shaft 1a so as to rotate thereon. Outer gearing of the third gear wheel 3 engages the outer teeth of a fourth gear wheel 4, which is connected in a rotationally fixed manner with a fifth gear wheel 5 disposed concentrically thereto, or it is connected as one piece therewith. The fifth gear wheel 5 has an outer gearing that engages the inner teeth of the first gear wheel 1. According to an alternative, the fourth gear wheel can mesh with the third gear wheel and the first gear wheel such that the fifth gear wheel can be eliminated.

The rotational axis 9 of the first gear wheel 1 coincides with its center line, the rotational axis 10 of the third gear wheel 3 coincides with its center line, the rotational axis 11 of the fourth gear wheel 4 coincides with its center line, the rotational axis 12 of the fifth gear wheel 5 coincides with its center line, and the rotational axis 13 of the second gear wheel 2 with its center line.

In particular, the rotational axis 9 of the first gear wheel 1 and the rotational axis 10 of the third gear wheel 3 coincide. Furthermore, the rotational axis 11 of the fourth gear wheel 4 and the rotational axis 12 of the fifth gear wheel 5 coincide. Each of the rotational axis 9 of the first gear wheel 1, the rotational axis 10 of the third gear wheel 3, the rotational axis 11 of the fourth gear wheel 4, and the rotational axis 12 of the fifth gear wheel 5 are fixed relative to the mounting 8.

The eccentric shaft 19 has a cylindrical body 20 disposed eccentrically thereto, which is connected to the eccentric shaft 19 in a non rotational manner, or it is configured as one piece therewith. The second gear wheel 2 is supported so as to rotate about the rotational axis 13 on the lateral surface of the cylindrical body 20, while interposing a rolling or ball bearing 7, which rotational axis coincides with the center line of the cylindrical body 20. Furthermore, the third gear wheel 3 is connected to the eccentric shaft 19 so as not to rotate and disposed concentrically thereto.

A drive system 16, by which the fourth gear wheel 4 can be rotated about the rotational axis 11, is fastened by a fastening means 24 to the mounting 8. By way of the fourth gear wheel 4, the third gear wheel 3 can be rotated about the rotational axis 10 and the fifth gear wheel 5 about the rotational axis 12, such that the first gear wheel 1 can be rotated about the rotational axis 9. The fastening means 24 and the drive system 16 are shown only schematically in the present example.

A ring 21 is connected in a rotationally fixed manner to the second gear wheel 2, or is configured as one piece therewith, the ring being disposed eccentrically to the second gear wheel 2. Adjustment movement can be picked up at the ring 21, which thus forms the pick-up location 14 for the adjustment movement. Since the ring 21 is fastened to the second gear wheel 2, one can also say that the adjustment movement is picked up on the second gear wheel 2. The adjustment movement is carried out relative to the mounting 8 and is linear or substantially linear, such that the ring 21 is guided in particular in a linear fashion.

The mounting 8 comprises a hollow-cylindrical rim 23 in which the first gear wheel 1, the second gear wheel 2, the third gear wheel 3, the fourth gear wheel 4, and the fifth gear wheel 5 are located. The drive system 16 may be disposed inside or outside the rim 23 and coupled to the fourth gear wheel 4, for example by way of a shaft and/or optionally an additional transmission or gear wheel.

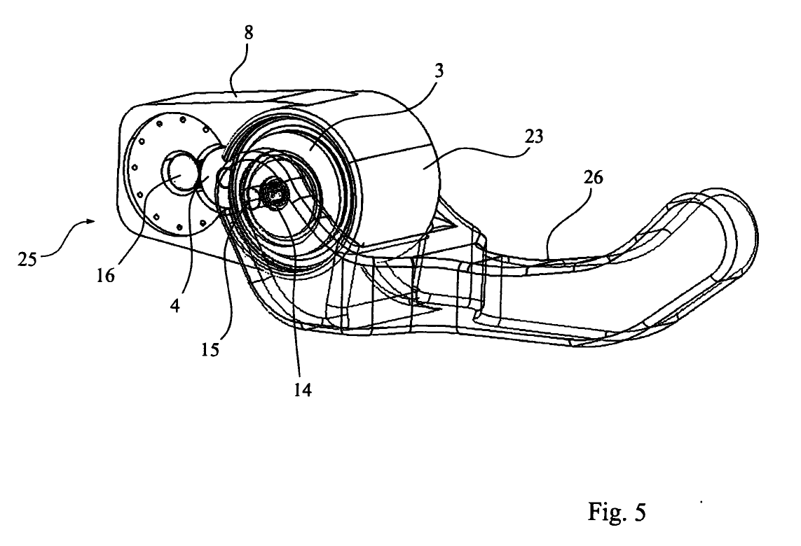

Seen in FIG. 5 is a perspective view of a control arm 26 connected to an adjustment drive 25 according to the invention for connecting a vehicle wheel to an auxiliary frame, wherein the mounting 8 of the adjustment drive 25 can be connected to the auxiliary frame or fastened thereto. Furthermore, on the end of the control arm 26 facing away from the adjustment drive 25, a ball joint may be fastened or disposed, and by means of which the control arm 26 can be linked to the vehicle wheel. The adjustment drive 25 shown in FIG. 5 corresponds to the first embodiment.

Alternatively, it is possible to also use the second embodiment, or modifications of the two embodiments, for the adjustment drive 25. In particular, two identical adjustment drives may be provided, which preferably have a common mounting 8, a common hollow-cylindrical rim 23, and/or a common drive system 16, wherein the pick-up locations 14 of both adjustment drives are located on the opposing ends of the hollow-cylindrical rim 23. In particular, the extensions 15 of the two adjustment drives extend out of the mutually opposing ends of the hollow-cylindrical rim 23.

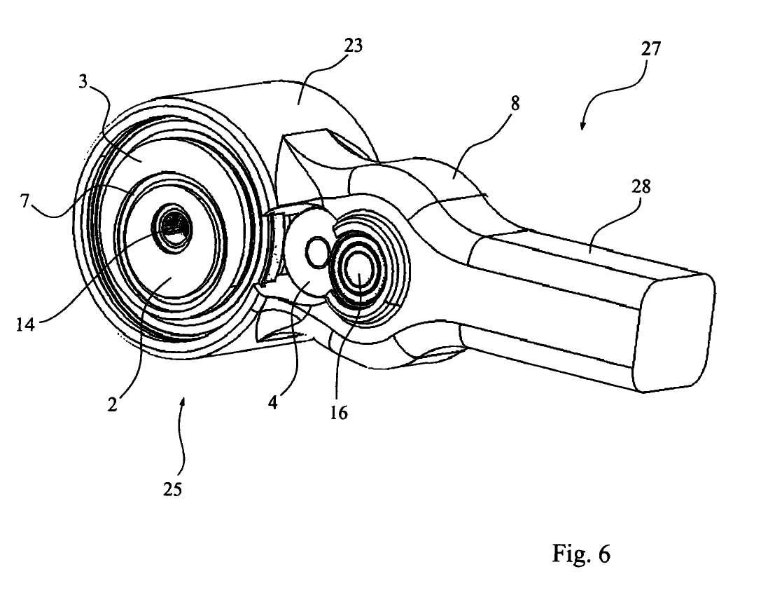

Seen in FIG. 6 is a perspective view of an adjustment drive 25 according to the invention having a control arm 27 for connecting a vehicle wheel to an automotive body, wherein the oblong base body 28 of the steering rod 27, following the hollow-cylindrical rim 23, is formed by the mounting 8 or is fixed thereto. Furthermore, a ball joint may be fastened or disposed on the end of the control arm 27 facing away from the adjustment drive 25, by means of which the control arm 27 can be linked to the vehicle wheel. The adjustment drive 25 shown in FIG. 6 corresponds to the first embodiment.

Alternatively, it is possible to also use the second embodiment, or modifications of the two embodiments, for the adjustment drive 25. In particular, as was explained above with respect to FIG. 5, two identical adjustment drives may be provided which preferably have a common mounting 8, a common hollow-cylindrical rim 23, and/or a common drive system 16, wherein the pick-up locations 14 of the two adjustment drives are located on the opposing ends of the hollow-cylindrical rim 23.

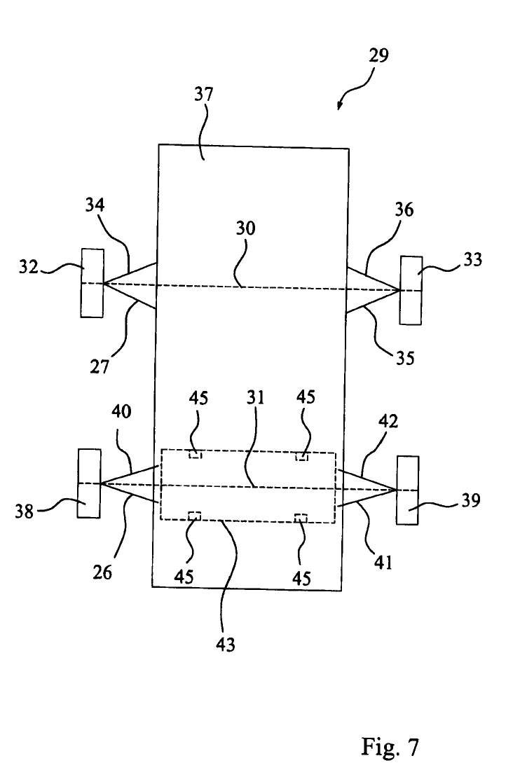

From FIG. 7 a schematic top view of a vehicle 29 is apparent, which has a first vehicle axle 30 and a second vehicle axle 31. The first vehicle axle 30 comprises two vehicle wheels 32 and 33 which are each connected to an automotive body 37 of the vehicle 29 by way of control arms 27, 34 or 35, 36. The control arm 27 corresponds to the control arm shown in FIG. 6, into which an adjustment drive 25 according to the invention is integrated. Furthermore, one or more of the control arms 34, 35 and 36 can likewise be equipped with the adjustment drive according to the invention in the same manner as the control arm 27.

The second vehicle axle 31 comprises two vehicle wheels 38 and 39, which are each coupled to an auxiliary frame 43 by way of control arms 26, 40 or 41, 42, wherein the auxiliary frame is fastened to the automotive body 37 by means of auxiliary frame bearings 45. The control arm 26 corresponds to the control arm shown in FIG. 5 which is connected to an adjustment drive 25 according to the invention, the mounting 8 of which is fastened to the auxiliary frame 43. One or more of the control arms 40, 41 and 42 can likewise be connected to the adjustment drive according to the invention, in particular in the same manner as the control arm 26.

Alternatively or additionally, it is possible to couple one or more bearings 45 to an adjustment drive according to the invention, with these bearings 45 being adjusted with respect to the automotive body 37. In this way, it is possible to manipulate the auxiliary frame 43, and hence the axle 31 including all associated parts, relative to the automotive body 37, such that the wheels 38 and 39 can be steered.

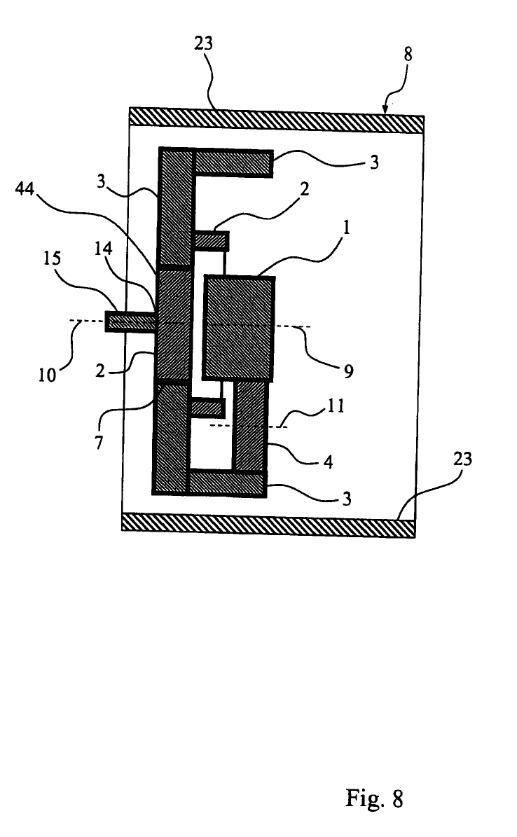

FIG. 8 shows a schematic view of an adjustment drive according to a modification of the first embodiment of the invention, wherein characteristics identical or similar to the first embodiment are denoted with the same reference numerals as in the first embodiment.

In this modification, the third wheel 3 has inner gearing which engage the outer teeth of the fourth gear wheel 4 which engage the outer teeth of the first gear wheel 1. In this way, the fifth gear wheel can be omitted. While according to FIG. 8, the sixth gear wheel is also omitted, alternatively it is possible, as in the first embodiment, to couple the sixth gear wheel concentrically to the first gear wheel 1 in a rotationally fixed manner, such that the outer teeth of the fourth gear wheel 4 engage the inner teeth of the third gear wheel 3 and the outer teeth of the sixth gear wheel. In this case, the outer teeth of the fourth gear wheel 4 no longer engage in the outer teeth of the first gear wheel 1.

The drive system, which is not shown in FIG. 8, drives the first gear wheel 1, the third gear wheel 3 and/or the fourth gear wheel 4. According to the alternative, the sixth gear wheel can also be driven by the drive system.

### LIST OF REFERENCE NUMERALS

1 First gear wheel
2 Second gear wheel
3 Third gear wheel
4 Fourth gear wheel
5 Fifth gear wheel
6 Sixth gear wheel
7 Rolling or plain bearing
8 Mounting
9 Rotational axis of the first gear wheel
10 Rotational axis of the third gear wheel
11 Rotational axis of the fourth gear wheel
12 Rotational axis of the fifth gear wheel
13 Rotational axis of the second gear wheel
14 Pick-up location
15 Extension
16 Drive system
17 Driving gear wheel
18 Rotational axis of the driving gear wheel
19 Eccentric shaft
20 Cylindrical body
21 Ring
22 Ring axis
23 Hollow-cylindrical rim
24 Fastening means
25 Adjustment drive
26 Control arm
27 Control arm
28 Base body of the control arm
29 Vehicle
30 First vehicle axle
31 Second vehicle axle
32 Vehicle wheel
33 Vehicle wheel
34 Control arm
35 Control arm
36 Control arm
37 Automotive body
38 Vehicle wheel
39 Vehicle wheel
40 Control arm
41 Control arm
42 Control arm
43 Auxiliary frame
44 Extension on the second wheel
45 Auxiliary frame bearing

1-14. (canceled)

15. An adjustment drive for local adjustment of a chassis component, the adjustment drive comprising a mounting (8), a first gear wheel (1) having a first center line (9) and being rotatable about the first center line (9), a second gear wheel (2) is disposed eccentrically to the first gear wheel (1) and has a second center line (13), which is parallel to the first center line (9), a third gear wheel (3) having a third center line (10) and being rotatable about the third center line (10), the third center line (10) is either parallel to or coincident with the first center line (9), and a drive system (16) is coupled to the mounting (8) and rotatably drives at least the first and third gear wheels (1, 3), the second gear wheel (2) is eccentric to the third gear wheel (3) and is supported on the third gear wheel (3) to rotate about the second center line (13), and the first gear wheel (1) is coupled to the second gear wheel (2) for transmitting rotary motion.

16. The adjustment drive according to claim 15, wherein the second gear wheel (2) is rotatable about the third center line (10).

17. The adjustment drive according to claim 15, wherein the second gear wheel (2) simultaneously rotates about the third center line (10) in one direction and about the second center line (13) in an opposite direction.

18. The adjustment drive according to claim 15, wherein the first gear wheel (1) and the second gear wheel (2) mesh with each other and form an internal gear pair.

19. The adjustment drive according to claim 15, wherein to transmit rotary motion, the first gear wheel (1) is coupled to a fourth gear wheel (4) which has a fourth center line (11) and rotates about the fourth center line (11), which is parallel to the first center line (9), the fourth gear wheel (4) is coupled to the third gear wheel (3) for transmitting rotary motion.

20. The adjustment drive according to claim 19, wherein to transmit rotary motion, the first gear wheel (1) is coupled to a fifth gear wheel (5) which has a fifth center line (12) and rotates about the fifth center line (12), which is parallel to the first center line (9), the fifth gear wheel (5) is coupled to the fourth gear wheel (4) for transmitting rotary motion.

21. The adjustment drive according to claim 18, wherein the first gear wheel (1) forms an inner gear wheel of the internal gear pair that is formed by the first gear wheel (1) and the gear second wheel (2), the third gear wheel (3) and a fourth gear wheel (4) mesh with each other, and a fifth gear wheel (5) meshes with the fourth gear wheel (4) and a sixth gear wheel (6) that is coupled to the first gear wheel (1) in a rotationally fixed manner.

22. The adjustment drive according to claim 18, wherein the second gear wheel (2) forms an inner gear wheel of the internal gear pair that is formed by the first gear wheel (1) and the second gear wheel (2), the third gear wheel (3) and a fourth gear wheel (4) mesh with each other, and a fifth gear wheel (5) meshes with the first gear wheel (1) and is coupled to the fourth gear wheel (4) so as not to rotate.

23. The adjustment drive according to claim 22, wherein a cylindrical body (21) is either connected to the second gear wheel (2) in a rotationally fixed manner, or is integral with the second gear wheel (2), the cylindrical body (21) is eccentric to the second gear wheel (2).

24. The adjustment drive according to claim 15, wherein the mounting (8) has a hollow-cylindrical rim (23) in which at least the first gear wheel (1), the second gear wheel (2), and the third gear wheel (3) are disposed.

25. Use of an adjustment drive for local adjustment of a chassis component (26) of a vehicle (29) relative to an automotive body (37) of the vehicle (29), the adjustment drive comprising a mounting (8), a first gear wheel (1) having a first center line (9) and being rotatable about the first center line (9), a second gear wheel (2) is disposed eccentrically to the first gear wheel (1) and has a second center line (13), which is parallel to the first center line (9), a third gear wheel (3) having a third center line (10) and being rotatable about the third center line (10), the third center line (10) is either parallel to or coincident with the first center line (9), and a drive system (16) is coupled to the mounting (8) and rotatably drives at least the first and third gear wheels (1, 3), the second gear wheel (2) is eccentric to the third gear wheel (3) and is supported on the third gear wheel (3) to rotate about the second center line (13), and the first gear wheel (1) is coupled to the second gear wheel (2) for transmitting rotary motion.

26. An adjustment drive (25) in combination with a vehicle having an automotive body (37), and at least one chassis component (26), the adjustment drive (25) adjusting a position of the chassis component (26) relative to the automotive body (37), the adjustment drive comprising a mounting (8), a first gear wheel (1) having a first center line (9) and being rotatable about the first center line (9), a second gear wheel (2) is disposed eccentrically to the first gear wheel (1) and has a second center line (13), which is parallel to the first center line (9), a third gear wheel (3) having a third center line (10) and being rotatable about the third center line (10), the third center line (10) is either parallel to or coincident with the first center line (9), and a drive system (16) is coupled to the mounting (8) and rotatably drives at least the first and third gear wheels (1, 3), the second gear wheel (2) is eccentric to the third gear wheel (3) and is supported on the third gear wheel (3) to rotate about the second center line (13), and the first gear wheel (1) is coupled to the second gear wheel (2) for transmitting rotary motion.

27. The combination according to claim 26, wherein the chassis component is a vehicle wheel (32) which is connected to the automotive body (37) by a control arm (27), and the adjustment drive (25) is either connected to the control arm (27) or integral with the control arm (27).

28. The combination according to claim 26, wherein the chassis component is a vehicle wheel (38) which is connected to an auxiliary frame (43) by a control arm (26), and the adjustment drive (25) is either connected to the control arm (26) or integral with the control arm (27).
